(19) United States
(12) Patent Application Publication
(10) Pub. No.: US 2004/0141270 A1
(43) Pub. Date: Jul. 22, 2004

(54) Semiconductor integrated circuit with electrostatic discharge protection

(75) Inventor: Kazuo Kaneki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Renesas Technology Corp., Tokyo (JP)

(21) Appl. No.: 10/703,595

(22) Filed: Nov. 10, 2003

(30) Foreign Application Priority Data
Jan. 17, 2003 (JP) 2003-009296

(51) Int. Cl. H02H 9/00

(52) U.S. Cl. 361/56

(57) ABSTRACT

A semiconductor integrated circuit includes a power supply line connected to a power supply supplying a first power supply voltage, an open drain output terminal supplied with a second power supply voltage higher than the first power supply voltage, from an external circuit, and a plurality of diodes. The diodes are connected in series between the open drain output terminal and the power supply line so that a direction from the open drain output terminal to the power supply line is a forward direction of the diodes. The number of the diodes is determined according to a potential difference between the first power supply voltage and the second power supply voltage.

### BACKGROUND OF THE INVENTION

1) Field of the Invention

The present invention relates to a semiconductor integrated circuit in which an electrostatic discharge (ESD) withstand voltage of an open drain output circuit or open collector output circuit is improved. More particularly, this invention relates to a semiconductor integrated circuit capable of realizing reduction in power consumption in addition to the improvement in the ESD withstand voltage.

2) Description of the Related Art

A conventional semiconductor integrated circuit will be explained below. Recently, the voltage at the power supply of integrated circuits (IC) has been increasingly reduced, and two or more power supply voltages have been often provided on a single substrate in various products using ICs. Therefore, it is necessary that an IC can output a signal at a higher voltage than a power supply voltage. As a method of solving this problem, there is known a method using open drain output.

FIG. 9 shows one example of an open drain output circuit provided in the conventional semiconductor integrated circuit. In FIG. 9, the output of an IC 9 that operates with a 3 V power supply 1 is connected to a 5 V IC 12 that is provided downstream of the IC 9 and that operates with a 5 V power supply 10. The IC 9 includes an open drain output circuit that employs an n-channel (“n-ch”) metal oxide semiconductor (MOS) transistor 3. A signal (ON/OFF control) generated in the IC 9 is input to the gate 4 of the n-ch MOS transistor 3, the source 5 of the n-ch MOS transistor 3 is connected to ground 2, and the drain 6 thereof is connected to an output terminal 8.

The output terminal 8 is connected to the 5 V power supply 10 via a resistor 11 having an appropriate resistance. By so constituting, if the n-ch MOS transistor 3 is turned on, a current is carried to the resistor 11 and the potential at the output terminal 8 becomes “L” level (ground level). If the n-ch MOS transistor 3 is turned off, the potential at the output terminal 8 becomes “H” level (power supply voltage level (5 V)). In other words, through this operation, the IC 9 operating with the 3 V power supply 1 can drive the 5 V IC 12.

Further, a diode 7 that absorbs electrostatic discharge (ESD) energy to protects the n-ch MOS transistor 3, is arranged between the output terminal 8 of the IC 9 and the ground 2. The anode of the diode 7 is connected to the ground 2, and the cathode thereof is connected to the output terminal 8.

FIG. 10 shows another example of the open drain output circuit provided in the conventional semiconductor integrated circuit. FIG. 10 differs from FIG. 9 only in that a diode 13 is provided between the output terminal 8 and the 3 V power supply 1. This diode 13 is intended to compensate for a low ESD withstand voltage of the n-ch MOS transistor 3. In the circuit shown in FIG. 10, however, a current is carried to the power supply 1 via the power supply 10, resistor 11, output terminal 8, and the diode 13 in this order, thus disadvantageously increasing power consumption.

As a circuit that has improved this disadvantage, there is known a semiconductor integrated circuit disclosed in Japanese Patent Application Laid-Open No. 5-3282 (FIG. 1) shown FIG. 11. In FIG. 11, a diode 14 is inserted between the diode 13 and the power supply 1 so that the diode 14 has opposite characteristics to those of the diode 13. By doing so, the counter-flow of the current is avoided.

However, the conventional semiconductor integrated circuit disclosed in Japanese Patent Application Laid-Open No. 5-3282 still has the following disadvantages to be solved.

It is assumed that a voltage applied at ESD is V_{ESD}, a withstand voltage when the diode 14 is applied with a reverse bias is BV_{di}, a voltage when the diode 13 is applied with a forward bias is V_{d}, a voltage at the power supply 1 is V_{VCCL}, and a voltage at the power supply 10 is V_{VCCH}, then it is required to satisfy the following expression (1) so as to prevent the counter-flow of the current.

V_{VCCH}−V_{VCCL}<V_{d}+BV_{di} (1)

In addition, it is required to satisfy the following expression (2) so that the diodes 13 and 14 function as surge protectors.

V_{ESD}>V_{d}+BV_{di} (2)

In other words, the following expression (3) should be satisfied.

V_{VCCH}−V_{VCCL}<V_{d}+BV_{di}<V_{ESD} (3)

If a surge voltage is applied, a voltage applied to the source 5 and drain 6 of the n-ch MOS transistor 3 is “V_{VCCL}+V_{d}+BV_{di}”. To protect the circuit, therefore, it is preferable that the expression (3) is satisfied and that the voltage “V_{VCCL}+V_{d}+BV_{di}” applied to the source 5 and drain 6, i.e., the voltage “V_{d}+BV_{di}” is as low as possible.

However, the voltage BV_{di} is normally very high as compared with the voltage V_{d}, and therefore a high voltage is applied to the n-ch MOS transistor 3. For example, even at V_{d} of 0.7, a voltage of 13.7 V is applied to the source 5 and drain 6 if BV_{di} is 10 V and V_{VCCL} is 3 V.

### SUMMARY OF THE INVENTION

The present invention has been achieved in order to solve the above problems. It is an object of this invention to provide a semiconductor integrated circuit that includes an open drain output circuit capable of realizing efficient circuit protection while reducing power consumption.

The semiconductor integrated circuit according to one aspect of this invention, includes a power supply line that is connected to a power supply supplying a first power supply voltage, and an open drain output terminal. The semiconductor integrated circuit also includes a plurality of diodes that are connected in series between the open drain output terminal and the power supply line so that a direction from the open drain output terminal to the power supply line is a forward direction of the diodes.

The semiconductor integrated circuit according to another aspect of this invention, includes a power supply line that is connected to a power supply supplying a first power supply voltage, and an open collector output terminal. The semiconductor integrated circuit also includes a plurality of diodes that are connected in series between the open collector output terminal and the power supply line so that a direction from the open collector output terminal to the power supply line is a forward direction of the diodes.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 shows the configuration of a first embodiment of an open drain output circuit in a semiconductor integrated circuit according to the present invention;

FIG. 2 shows a first application of the open drain output circuit shown in FIG. 1;

FIG. 3 shows a second application of the open drain output circuit shown in FIG. 1;

FIG. 4 shows a third application of the open drain output circuit shown in FIG. 1;

FIG. 5 shows a fourth application of the open drain output circuit shown in FIG. 1;

FIG. 6 shows another configuration of the open drain output circuit in the semiconductor integrated circuit according to the present invention;

FIG. 7 shows the configuration of a second embodiment of the open drain output circuit in the semiconductor integrated circuit according to the present invention;

FIG. 8 shows the configuration of a third embodiment of the open drain output circuit in the semiconductor integrated circuit according to the present invention;

FIG. 9 shows one example of the open drain output circuit in a conventional semiconductor integrated circuit;

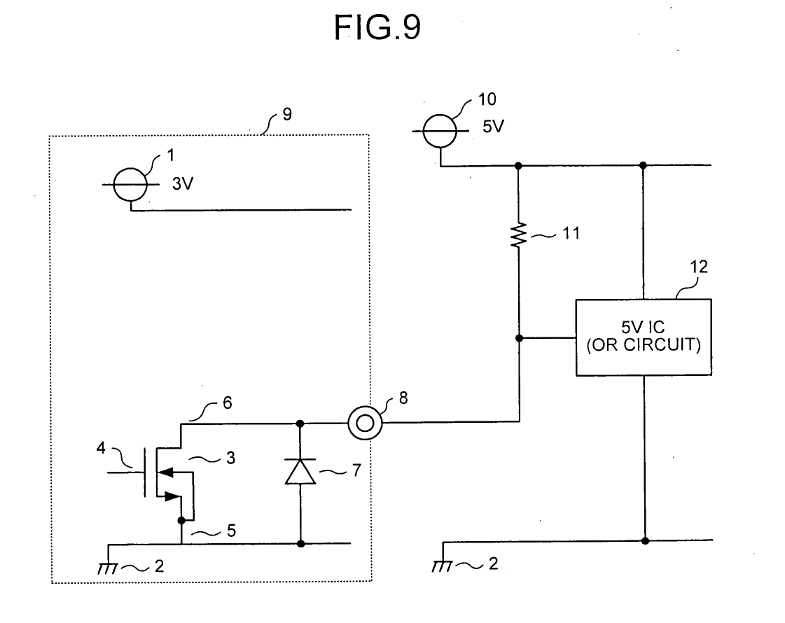

FIG. 10 shows another example of the open drain output circuit in the conventional semiconductor integrated circuit; and

FIG. 11 shows still another example of the open drain output circuit in the conventional semiconductor integrated circuit.

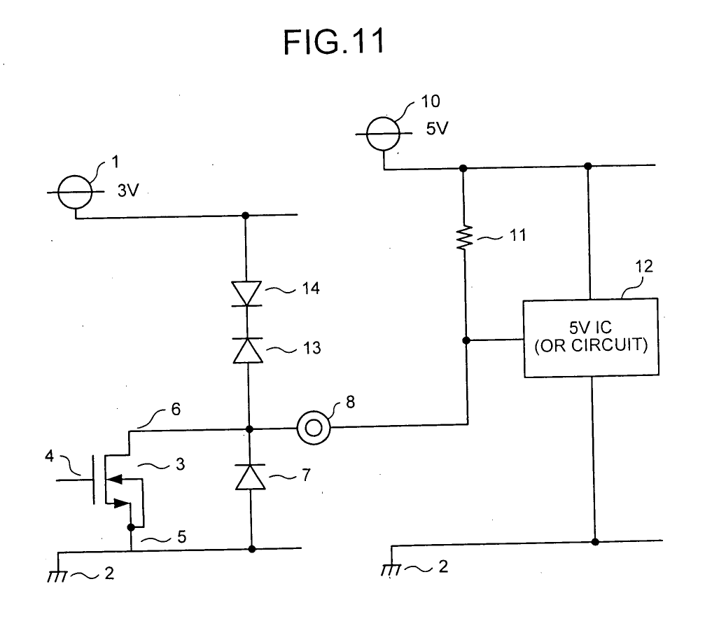

### DETAILED DESCRIPTION

Embodiments of the present invention will be explained in detail below with reference to the accompanying drawings. It should be noted that the present invention is not limited by the embodiments.

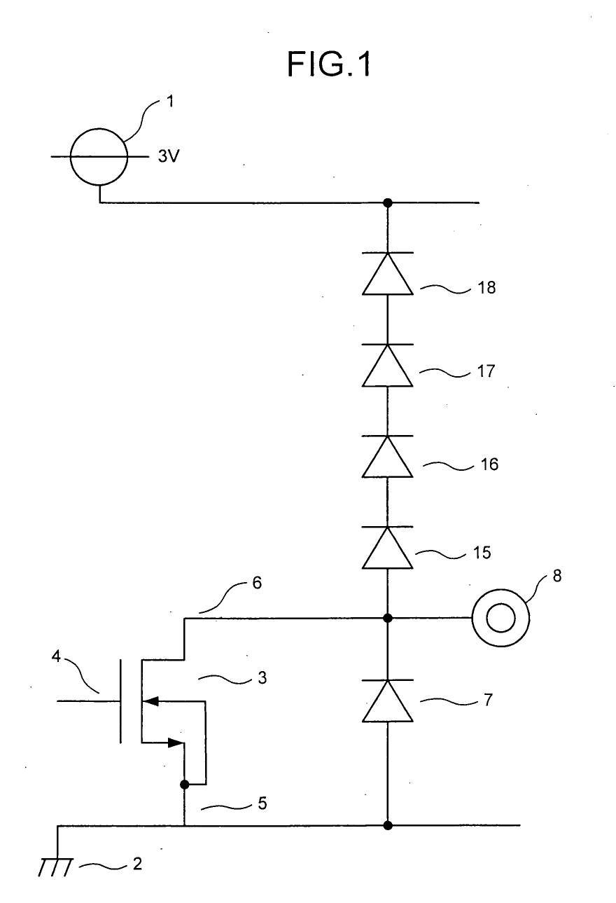

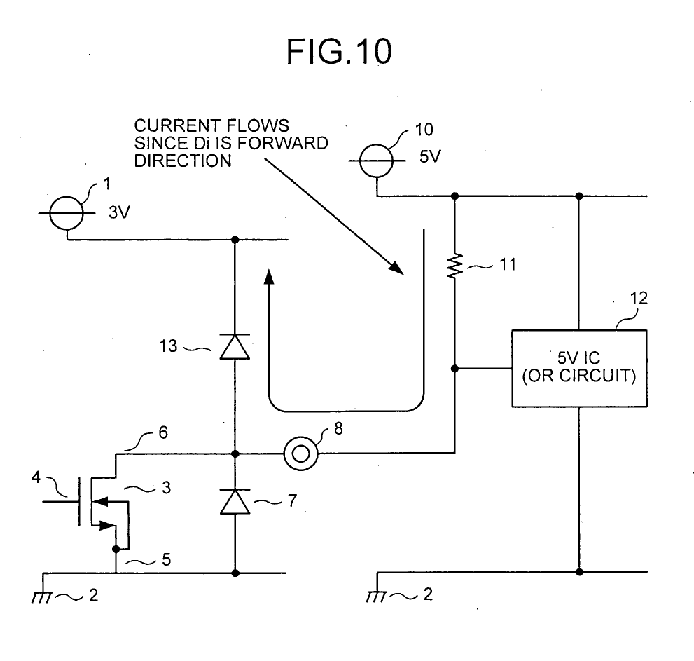

FIG. 1 shows the configuration of a first embodiment of the open drain output circuit in the semiconductor integrated circuit (IC) according to the present invention. By way of example, it is assumed herein that the output terminal 8 of the 3 V IC that operates with the 3 V power supply 1 is connected to the 5 V IC that operates with the 5 V power supply 10 (see FIG. 10).

The 3 V IC shown in FIG. 1 includes the open drain output circuit that employs the n-ch MOS transistor 3. Specifically, the signal (ON/OFF control) generated in the 3 V IC is input to the gate 4 of the n-ch MOS transistor 3, the source 5 of the n-ch MOS transistor 3 is connected to the ground 2, and the drain 6 thereof is connected to the output terminal 8.

The output terminal 8 is connected to the 5 V power supply 10 via the pull-up resistor 11 in which an appropriate resistance value is set (see FIG. 10). By so constituting, if the n-ch MOS transistor 3 is turned on, a current is carried to the resistor 11 and the potential at the output terminal 8 becomes “L” level (ground level). If the n-ch MOS transistor 3 is turned off, the potential at the output terminal 8 becomes “H” level (power supply voltage level (5 V)). That is, through this operation, the 3 V IC can drive the 5 V IC.

The diode 7 that absorbs ESD (Electrostatic Discharge) energy and protects the n-ch MOS transistor 3 is arranged between the output terminal 8 of the 3 V IC and the ground 2. The anode of the diode 7 is connected to the ground 2, and the cathode thereof is connected to the output terminal 8.

In the first embodiment, as shown in FIG. 1, diodes 15, 16, 17, and 18 are connected in series between the output terminal 8 and the power supply 1 (power supply line) so that a direction from the output terminal 8 to the power supply 1 becomes forward direction. Specifically, the anode of the diode 15 is connected to the output terminal 8, and the cathode of the diode 18 is connected to the power supply 1. These diodes are intended to compensate for the low ESD withstand voltage of the n-ch MOS transistor 3 and to prevent the counter-flow of a current, that is, the current from flowing from the 5 V power supply 10 to the 3 V power supply 1.

The reason why the four diodes are connected in series will be explained. For example, if the voltage V_{VCCL} of the power supply 1 is 3 V, the voltage V_{VCCH} of the power supply 10 is 5 V, the voltage applied at ESD is V_{ESD}, and the voltage V_{d} when the respective diodes are applied with forward biases is 0.6 V, then it is required to satisfy the following conditional expression (4) for the number X of diodes so as to prevent the counter-flow of the current.

V_{VCCH}−V_{VCCL}<X×V_{d} (4)

It is also required to satisfy the following expression (5) so that these diodes function as surge protectors.

V_{ESD}>X×V_{d} (5)

In other words, the following expression (6) should be satisfied.

V_{VCCH}−V_{VCCL}<X×V_{d}<V_{ESD} (6)

If a surge voltage is applied, a voltage applied to the source 5 and drain 6 of the n-ch MOS transistor 3 is “V_{VCCL}+X×V_{d}”. Therefore, in order to protect the circuit, it is preferable that the expression (6) is satisfied and that the voltage “V_{VCCL}+X×V_{d}” applied to the source 5 and drain 6, i.e., the voltage “X×V_{d}” is as low as possible. To satisfy these conditions, four diodes (0.6×4=2.4 V) are necessary. More specifically, the potential difference among the four diodes is not less than 2 V (5 V−3 V) and the four is the minimum number.

As can be seen, in the first embodiment, if an external circuit that operates with a power supply at a higher voltage than the operating power supply of the IC that includes the open drain output circuit provided in the semiconductor integrated circuit, is to be driven, a plurality of diodes, determined in accordance with the potential difference between the power supply voltage supplied to the IC and the power supply voltage of the external circuit, are connected in series between the output terminal and the power supply line of the IC so that the direction from the output terminal of the open drain output circuit to the power supply line of the IC becomes forward direction. By so constituting, it is possible to prevent a counter current from being carried from the external power supply to the power supply line in the IC, and to thereby reduce power consumption. In addition, the voltage applied to the n-ch MOS transistor when ESD is applied can be adjusted by V_{d} in the range of the expression (6), i.e., suppressed to be low. It is, therefore, possible to improve the ESD protection effect.

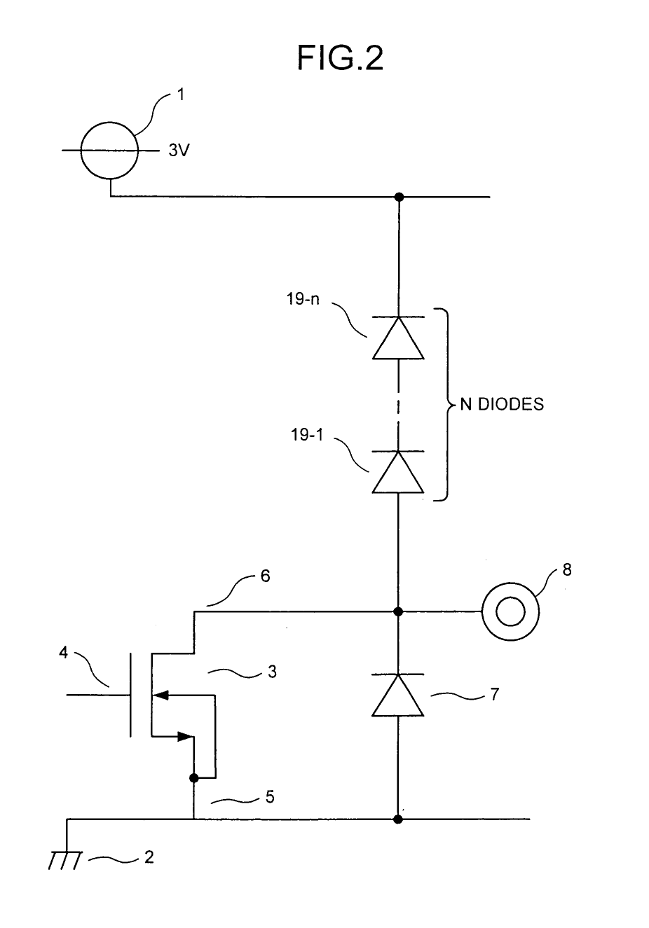

FIG. 2 shows a first application of the open drain output circuit shown in FIG. 1. In this embodiment, as shown in FIG. 2, the number of diodes provided between the output terminal of the open drain output circuit and the power supply line of the IC may be changed in consideration of the temperature characteristics of the diodes (diodes 19-1 to 19-n in FIG. 2). Even if the number of diodes is changed, the same advantage can be attained. Besides this, it is possible to obtain the open drain output circuit in consideration of the temperature characteristics of the diodes.

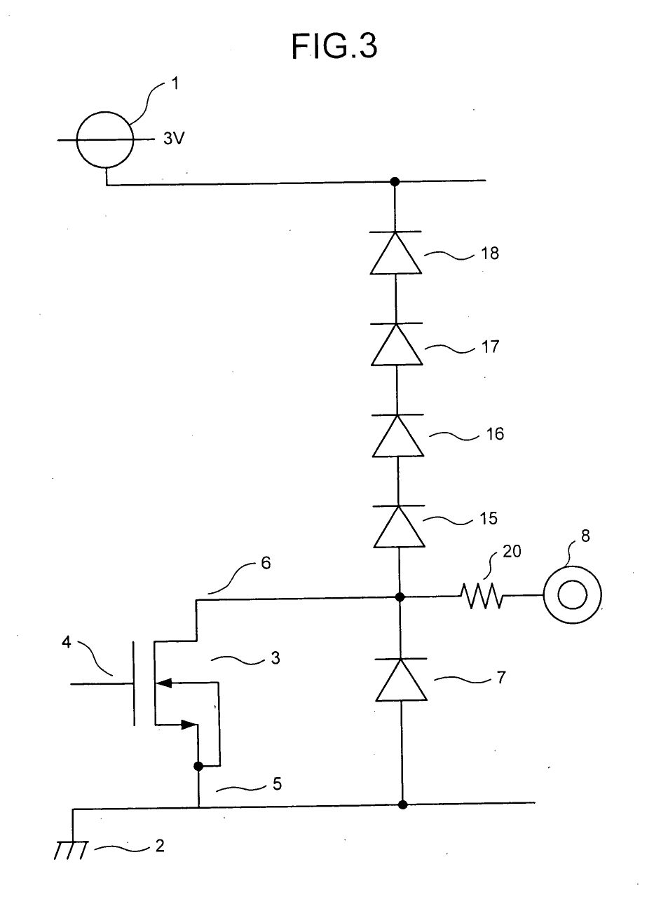

FIG. 3 shows a second application of the open drain output circuit shown in FIG. 1. In this embodiment, as shown in FIG. 3, a resistor 20 may be added right before the output terminal 8 of the open drain output circuit. By so adding, the ESD energy can be also absorbed by this resistor 20, making it possible to further improve the ESD withstand voltage. In this embodiment, the characteristic configuration of FIG. 3 may be applied to the open drain output circuit shown in FIG. 2.

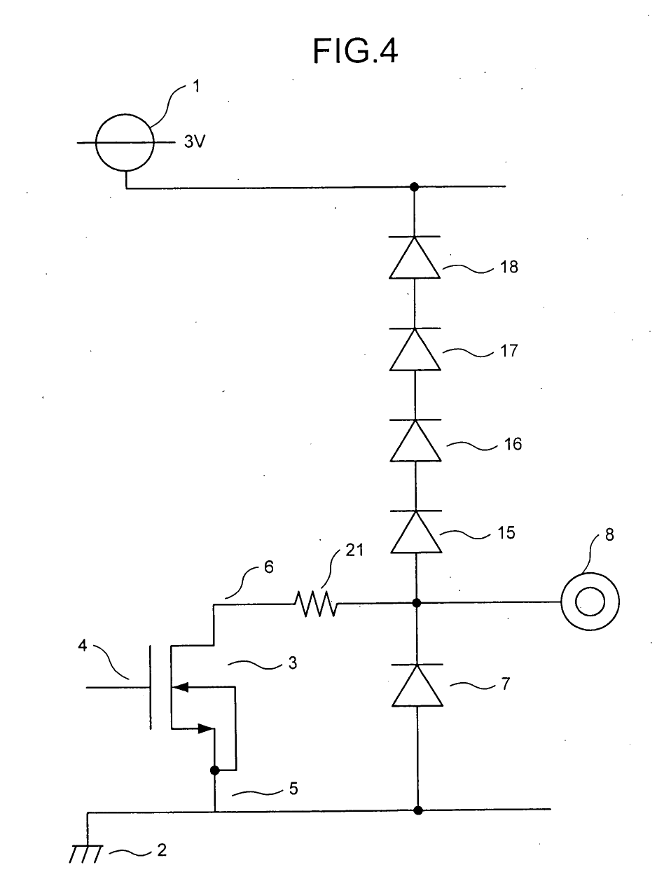

FIG. 4 shows a third application of the open drain output circuit shown in FIG. 1. In this embodiment, as shown in FIG. 4, a resistance 21 may be added right before the drain 6 of the n-ch MOS transistor 3. By so adding, the ESD energy can be also absorbed by this resistance 21, making it possible to further improve the ESD withstand voltage. In this embodiment, the characteristic configuration of FIG. 4 may be applied to the open drain output circuit shown in FIG. 2.

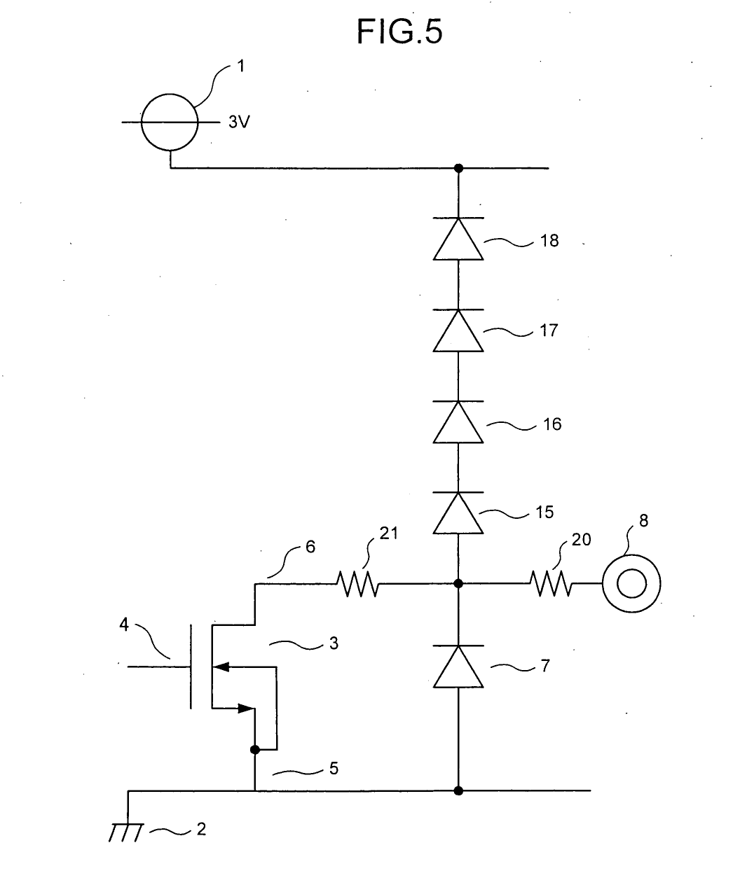

FIG. 5 shows a fourth application of the open drain output circuit shown in FIG. 1. By combining the characteristic configuration of FIG. 3 with that of FIG. 4, it is possible to further improve the ESD withstand voltage. In this embodiment, the characteristic configuration of FIG. 5 may be applied to the open drain output circuit shown in FIG. 2.

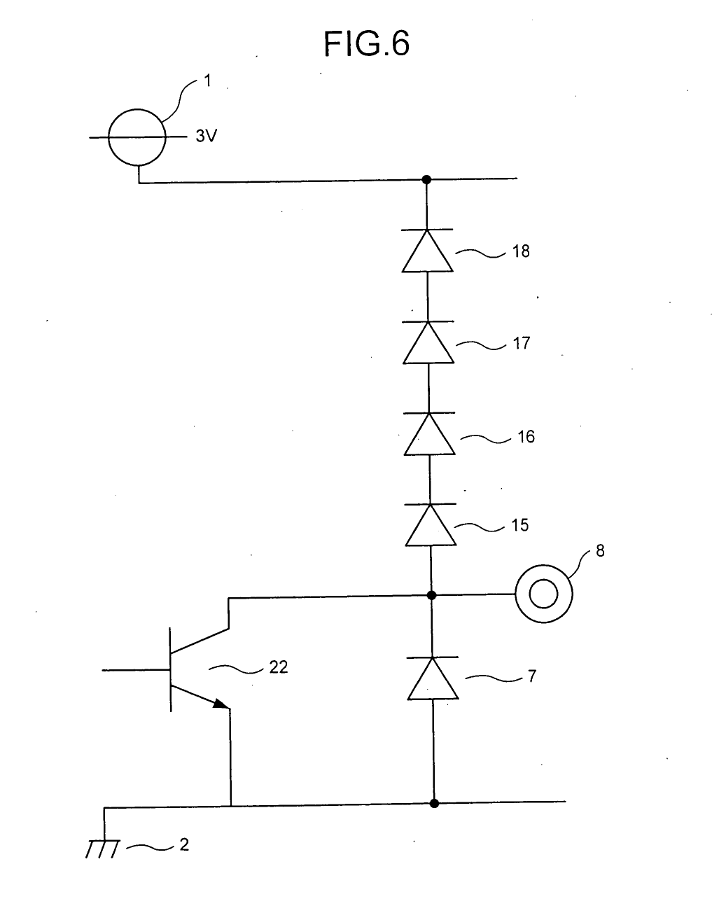

In the first embodiment, the open drain output circuit that employs the n-ch MOS transistor 3 (see FIGS. 1 to 5) has been explained. However, the present invention is not limited to this embodiment. Any of the characteristic configurations of FIGS. 1 to 5 may be applied to, for example, an open collector output circuit that employs a bipolar transistor 22 shown in FIG. 6. By doing so, it is possible to obtain the same advantage as that of the open drain output circuit shown in each of FIG. 1 to FIG. 5.

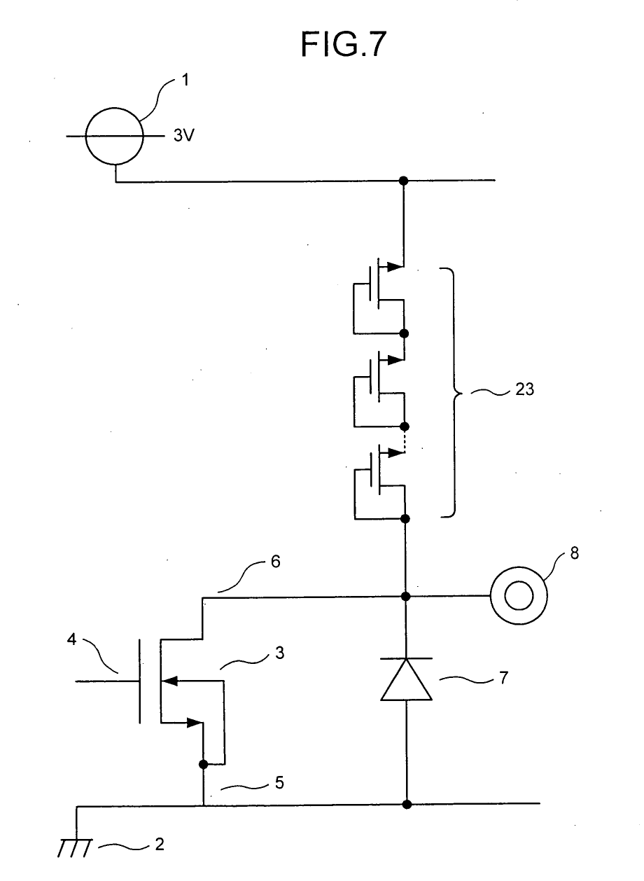

FIG. 7 shows the configuration of a second embodiment of the open drain output circuit in the semiconductor integrated circuit according to the present invention. In the second embodiment, the diodes (15 to 18, 19-1 to 19-n) arranged between the output terminal 8 and the power supply 1 in the open drain output circuit (see FIGS. 1 to 5) or the open collector output circuit (see FIG. 6) in the first embodiment, are replaced by n-ch MOS transistors 23 each having a gate and a drain equal in potential. Alternatively, the n-ch MOS transistors 23 may be replaced by p-channel (“p-ch”) MOS transistors. By so constituting, it is possible to obtain the same advantage as that explained in the first embodiment.

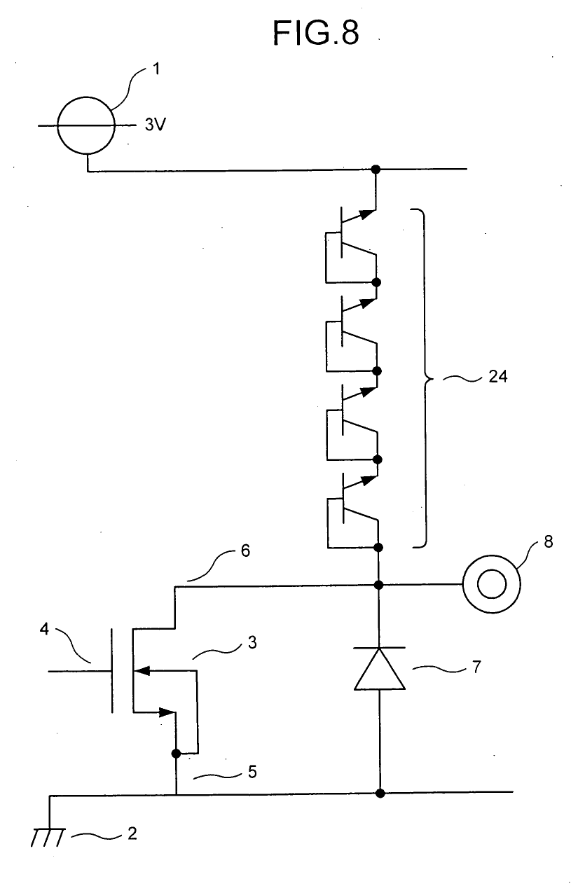

FIG. 8 shows the configuration of a third embodiment of the open drain output circuit in the semiconductor integrated circuit according to the present invention. In the third embodiment, the diodes (15 to 18, 19-1 to 19-n) arranged between the output terminal 8 and the power supply 1 in the open drain output circuit (see FIGS. 1 to 5) or the open collector output circuit (see FIG. 6) in the first embodiment, are replaced by NPN bipolar transistors 24 each having a base and a collector equal in potential. Alternatively, the NPN bipolar transistors 24 may be replaced by PNP bipolar transistors. By so constituting, it is possible to obtain the same advantage as that explained in the first embodiment.

As explained so far, according to the present invention, if an external circuit that operates with the second power supply voltage higher than the first power supply voltage supplied into inside of the semiconductor integrated circuit, is to be driven, a plurality of diodes determined in accordance with the potential difference between the first power supply voltage and the second power supply voltage are connected in series between the output terminal of the open drain output circuit and the power supply line in the IC so that a direction from the output terminal to the internal power supply line becomes forward direction. By so constituting, it is advantageously possible to prevent a counter current from being carried from the external power supply to the power supply line in the IC, and to thereby reduce power consumption. In addition, the voltage applied to the n-ch MOS transistors when ESD is applied can be suppressed to be low. It is, therefore, possible to improve the ESD protection effect.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor integrated circuit comprising:
a power supply line that is connected to a power supply supplying a first power supply voltage;
an open drain output terminal; and
a plurality of diodes that are connected in series between the open drain output terminal and the power supply line so that a direction from the open drain output terminal to the power supply line is a forward direction of the diodes.

2. The semiconductor integrated circuit according to claim 1, wherein
the open drain output terminal is supplied with a second power supply voltage higher than the first power supply voltage from an external circuit, and
the number of the diodes is determined in accordance with a potential difference between the first power supply voltage and the second power supply voltage.

3. The semiconductor integrated circuit according to claim 1, wherein each of the diodes is realized as a metal oxide semiconductor (MOS) transistor whose gate and drain are short-circuited.

4. The semiconductor integrated circuit according to claim 1, wherein each of the diodes is realized as a bipolar transistor whose base and collector are short-circuited.

5. The semiconductor integrated circuit according to claim 1, further comprising a transistor for making an output voltage at the open drain output terminal a low level, the transistor including (i) a drain connected to a first stage of the plurality of diodes and (ii) a source connected to ground.

6. The semiconductor integrated circuit according to claim 5, wherein the drain is connected to the first stage of the plurality of diodes with a resistor interposed therebetween.

7. The semiconductor integrated circuit according to claim 6, wherein the first stage of the plurality of diodes is connected to the open drain output terminal with another resistor interposed therebetween.

8. The semiconductor integrated circuit according to claim 1, wherein a first stage of the plurality of diodes is connected to the open drain output terminal with a resistor interposed therebetween.

9. A semiconductor integrated circuit comprising:
a power supply line that is connected to a power supply supplying a first power supply voltage;
an open collector output terminal; and
a plurality of diodes that are connected in series between the open collector output terminal and the power supply line so that a direction from the open collector output terminal to the power supply line is a forward direction of the diodes.

10. The semiconductor integrated circuit according to claim 9, wherein
the open drain output terminal is supplied with a second power supply voltage higher than the first power supply voltage from an external circuit, and
the number of the diodes is determined in accordance with a potential difference between the first power supply voltage and the second power supply voltage.

11. The semiconductor integrated circuit according to claim 9, wherein each of the diodes is realized as a metal oxide semiconductor (MOS) transistor whose gate and drain are short-circuited.

12. The semiconductor integrated circuit according to claim 9, wherein each of the diodes is realized as a bipolar transistor whose base and collector are short-circuited.
